(19) United States
(12) Patent Application Publication
(10) Pub. No.: US 2020/0005357 A1
(43) Pub. Date: Jan. 2, 2020

(54) CO-PROMOTIONS BASED ON MEASURED PHYSICAL SPACE PARAMETERS

(71) Applicant: Microsoft Technology Licensing, LLC, Redmond, WA (US)

(72) Inventors: Kenneth Liam KIEMELE, Redmond, WA (US); Donna Katherine LONG, Redmond, WA (US); Priya GANADAS, Seattle, WA (US); Bryant Daniel HAWTHORNE, Duvall, WA (US); John Benjamin HESKETH, Kirkland, WA (US); Jamie R. CABACCANG, Bellevue, WA (US); Jennifer Jean CHOI, Seattle, WA (US)

(73) Assignee: Microsoft Technology Licensing, LLC, Redmond, WA (US)

(21) Appl. No.: 16/020,869

(22) Filed: Jun. 27, 2018

(51) Int. Cl. G06Q 30/02

(52) U.S. Cl. CPC G06Q 30/0259; G06Q 30/0276; G06Q 30/0224; G06Q 30/0261; G06Q 30/0205

(57) ABSTRACT

A computer system is provided that includes a server configured to store a plurality of location accounts, each location account being associated with a physical space at a recorded geospatial location. The plurality of location accounts utilize shared data definitions of a physical space parameter. Each physical space is equipped with a corresponding on-premise sensor configured to detect measured values for the physical space parameter over time and send to the server a data stream indicating the measured values. The server further includes a promotion engine configured to determine similarities between measured values of the physical space parameter for the plurality of location accounts and generate co-promotions between location accounts of the plurality of location accounts based on the determined similarities. The computer system further includes a user interface system, via which an authorized user for a location account can view and accept a co-promotion.

### BACKGROUND

Economical sensors have been developed that can measure and record various types of data in a physical environment, and upload that data to computer devices that can integrate data from a multitude of such sensors. The collection of data gathered from the multitude of sensors can be used to gain insights and knowledge about trends within that physical environment. However, this measured data takes time to gather, and is typically siloed within the organization that is collecting the data. As a result, these organizations potentially may only be able to leverage their own data to identify promotional opportunities and may miss potential co-promotional opportunities with proprietors of other physical spaces.

### SUMMARY

A computer system is provided that may include a server configured to store a plurality of location accounts, each location account being associated with a physical space at a recorded geospatial location. The plurality of location accounts may utilize shared data definitions of a physical space parameter. Each physical space may be equipped with a corresponding on-premise sensor configured to detect measured values for the physical space parameter over time and send to the server a data stream indicating the measured values. The server may include a promotion engine configured to determine similarities between measured values of the physical space parameter for the plurality of location accounts and generate co-promotions between location accounts of the plurality of location accounts based on the determined similarities. The computer system may further include a user interface system, via which an authorized user for a location account can view and accept a co-promotion between the location account and one or more other location accounts generated by the promotion engine.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a computer system including a server having a promotion engine, a user interface system, and a plurality of client computing devices according to one implementation of the present disclosure.

FIG. 2 shows an example physical space including on-premise sensors configured to send measured values to the server of the computer system of FIG. 1.

FIG. 3 shows an example user interface of the user interface system of the computer system of FIG. 1.

FIG. 4 shows another schematic view of the computer system of FIG. 1.

FIG. 5 shows another example user interface of the user interface system of the computer system of FIG. 1.

FIG. 6 shows an example co-promotion generated using the computer system of FIG. 1.

FIG. 7 shows a flowchart illustrating a method for generating co-promotions based on measured values of physical space parameters implemented by the computer system of FIG. 1.

FIG. 8 is a schematic view of an example computing environment in which the computer system of FIG. 1 may be enacted.

### DETAILED DESCRIPTION

Economical sensors have been developed that can measure and record various types of data in a physical environment, such as customer demographic data, point of service data, temperature data, and other types of data that may be leveraged to gain valuable insights about that physical environment. Proprietors of the physical space/environment can use the gathered data to take suitable actions, such as adding or removing products and services, and creating suitable promotional efforts to sell those products and services. However, this measured data takes time to gather, and is typically siloed within the organization that is collecting the data.

As a result, these organizations potentially may only be able to leverage their own data to identify promotional opportunities and may miss potential co-promotional opportunities with proprietors of other physical spaces. While current social networks exist for individuals to interact with each other and exchange messages, photos and videos, and status updates, these social networks do not allow entities to share data collected by instruments in a physical space and organized in a structured manner enforced by the network. As a result, the opportunity to collaborate and leverage of data collected at other physical spaces is limited.

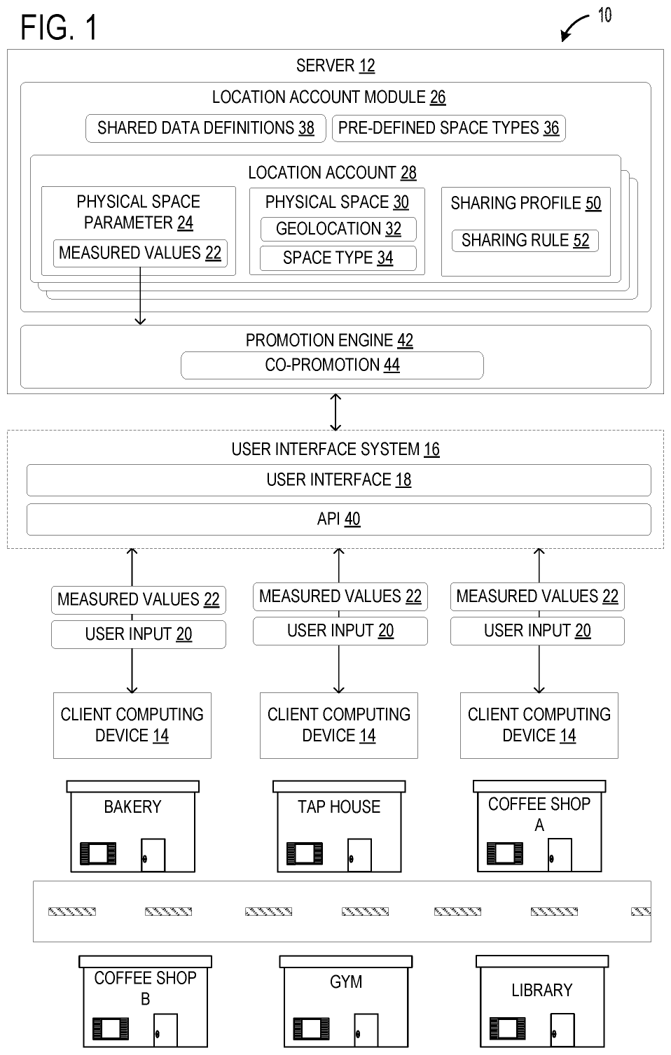

To address these issues, a computer system 10 is provided. FIG. 1 illustrates a schematic view of the computer system 10 for sharing measured data and identifying co-promotional opportunities among a plurality of different physical spaces, which, for example, may include businesses or other entities located in buildings such as restaurants, stores, offices, etc. In other examples, the physical spaces may include locations that are not located in a building, such as a farm, an athletic track, an outside area, etc. It will further be appreciated that other types of physical spaces and locations not specifically enumerated herein may utilize the computer system 10 to share measured data and establish co-promotions.

As shown, the computer system 10 includes a server 12 and a plurality of client computing devices 14 that communicate with the server 12 via a user interface system 16. In one example, the user interface system 16 is implemented by the server 12. In another example, the user interface system 16 is implemented by a separate computing device configured to communicate with the server 12 and is accessible by the plurality of client computing devices 14. The user interface system 16 includes a user interface 18 that is presented to users via a browser or client-side application executed on the client computing device 14. Each user may enter user input 20 to the user interface 18 of the user interface system 16 via input devices of their respective client computing devices 14, such as, for example, a keyboard and mouse. Each user, which, for example, may be authorized users for each physical space, such as the illustrated Bakery, Tap House, Coffee Shop A, Coffee Shop B, Gym, or Library, may select a subset of measured values 22 of physical space parameters 24 to upload to the server 12 for sharing with other users.

In one example, the server 12 may take the form of a single server computing device configured to perform the processes and methods described herein. In this example, the server 12 may include a processor, non-volatile storage, volatile storage, and other suitable computing components. In another example, the server 12 may include a plurality of server computing devices configured to work in a cloud computing configuration to implement the processes and methods described herein. The server 12 is configured to communicate with the plurality of client computing devices 14 via the user interface system 16.

Each of the client computing devices 14 may also include a processor, non-volatile storage, volatile storage, and other suitable computing components, such as an input device and display. Each client computing device 14 is configured to, via a browser or client-side application, interact with the user interface 18 of the user interface system 16 to select a subset of measured values 22 of one or more physical space parameters 24 measured by on-premise sensors of a physical space, and send those measured values 22 to the server 12 via the user interface system 16 for sharing with other users. In one example, the client computing device 14 may take the form of a desktop computing device. However, it will be appreciated that the client computing device 14 may take other forms, such as, for example, a laptop, a tablet computing device, a mobile computing device, or a computing device integrated into a point of sale system.

The measured values 22 of the one or more physical space parameters 24 sent by each client computing device 14 are received by and stored on the server 12. As illustrated, the server 12 includes a location account module 26 configured to store a plurality of location accounts 28. Each location account 28 is associated with a physical space 30 at a recorded geospatial location 32. In the illustrated example, the physical spaces 30 may include the illustrated Bakery, Tap House, Coffee Shop A, Coffee Shop B, Gym, and Library. Each physical space 30 has a recorded geospatial location 32, which is where the building, field, or area of the physical space 30 is located. In one example, the recorded geospatial location 30 may be a street address. In another example, the recorded geospatial location 30 may be a GPS location. In yet another example, the recorded geospatial location 30 may be a map location on a two or three-dimensional map of an area. Additionally, it will be appreciated that the example physical spaces 30 illustrated in FIG. 1 are merely exemplary, and that the physical space 30 may take other suitable forms, such as, for example, non-covered physical spaces such as a track and field, a farm, a golf course, etc., as discussed above.

Each location account 28 may also include a space type 34 associated with the physical space 30 selected from a plurality of pre-defined space types 36. The plurality of pre-defined space types 36 define what type of physical space 30 is associated with that location account 28. In the illustrated example, the plurality of pre-defined space types 36 may include a Bakery space type, a Tap House space type, a Coffee Shop space type, a Gym space type, and a Library space type. However, it will be appreciated that the plurality of pre-defined space types 36 may include other space types not shown in the illustrated example, such as a Farm space type, a Golf Course space type, a Track and Field space type, or any other suitable space type. An authorized user for a location account 28 may select an appropriate space type 34 to be associated with their location account 28 via the user interface 18 of the user interface system 16. It will be appreciated that multiple location accounts 28 may each be associated with the same space type from the plurality of pre-defined space types 36. In the illustrated example, a location account 28 for the Coffee Shop A physical space may have the same Coffee Shop space type as a location account 28 for the Coffee Shop B physical space.

In addition to utilizing a shared set of predefined space types 36, the plurality of location accounts 28 may utilize shared data definitions 38 of one or more physical space parameters 24. In one example, the one or more physical space parameters 24 may include temperature, lighting, music, density of persons, customer demographics, point of sale data, store hours, day of year, time of day, product types, display types, and store layout. As other examples, the physical space parameters may include atmospheric gas composition, wavelengths of ambient light, vibration, customer interactions with objects in the store, employee's interactions with customers in the physical store. However, it will be appreciated that the one or more physical space parameters 24 may include other types of physical space parameters not listed above. For each type of physical space parameter 24, the server 12 may include a shared data definition 38 for measured values of that physical space parameter. For example, a temperature physical space parameter may have a shared data definition 38 of Celsius or Fahrenheit. As a few other non-limiting examples, a lighting physical space parameter may have a light intensity shared data definition. A music physical space parameter may have a music title or music genre shared data definition. A density of persons physical space parameter may have a number of persons per area shared data definition. A customer demographics physical space parameter may have an anonymized demographic shared data definition, such as, for example, age, race, purchasing habits, etc. A point of sale data physical space parameter may have currency shared data definitions, such as dollars. A store hours physical space parameter may have a time of day range shared data definition for each day of the year. A product type physical space parameter may have a shared data definition for each type of sellable product or service. A display type physical space parameter may have shared data definitions for how products may be displayed in a store, such as via a shelf, in a display case, etc. A store layout physical space parameter may have shared data definitions for non-product objects that may be placed in physical spaces, such as furniture, decorations, etc. It will be appreciated that the physical space parameters 24 and the shared data definitions 38 for each physical space parameter 24 are not limited to the examples described above.

In one example, the measured values 22 of the physical space parameters 24 sent by each client computing device 14 must comply with the shared data definitions 38 to be uploaded to the server 12. The measured values 22 of the physical space parameters 24 may also be forced to comply with data protection regulations and anonymized to be uploaded to the server 12. In one example, the user interface system 16 may include an API 40 that provides functionality for each of the client computing devices 14 to upload their measured values 22. The API 40 may perform data type checking and data protection regulation checking on the measured values 22 to verify that each measured value 22 uploaded by the client computing device 14 conforms to the shared data definitions 38 set by the server 12. Thus, the measured values 22 of the one or more physical space parameters 24 stored on the server 12 for each location account 28 all conform to the shared data definitions 38 defined by the server 26 and enforced by the API 40 of the user interface system 16. In this manner, the measured values from a first location account 28 may be programmatically compared to the measured values of a second location account 28.

As illustrated in FIG. 1, the server 12 further includes a promotion engine 42 configured to compare measured values 22 of physical space parameters 24 among the plurality of location accounts 28 stored on the server 12 and determine similarities between measured values 22 of the physical space parameter 24 for the plurality of location accounts 28 based on the comparisons. For example, the promotion engine 42 may compare measured values for a customer demographics physical space parameter between a first and second location account and determine that the first and second location accounts have similar customer demographics. That is, the type of customer that patronizes the physical space of the first location account also patronizes the physical space of the second location account.

The promotion engine 32 may be configured to generate co-promotions 44 between location accounts of the plurality of location accounts 28 based on the determined similarities. As a specific example, the customer demographics of the Coffee Shop A may be similar to the customer demographics of the Bakery illustrated in FIG. 1. Based on identifying the similarity in customer demographics, the promotion engine 42 may identify that there is a co-promotional opportunity between the Coffee Shop A and the Bakery, such as, for example, a mutual discount for customers that patronize both businesses. It should be appreciated that similarities or trends may be identified by comparing measured values 22 for any suitable physical space parameters 24, such as, for example, comparing measured values 22 for temperature, lighting, music, density of persons, customer demographics, point of sale data, store hours, day of year, time of day, product types, display types, store layout, atmospheric gas composition, wavelengths of ambient light, vibration, customer interactions with objects, or employee interactions with customers. Further, the promotion engine 42 may generate co-promotions 44 based on similarities and trends identified for any of the above physical space parameters 24 among the plurality of location accounts 28.

In one non-limiting co-promotion example, the promotion engine 42 may detect that there is an overlap between the customer demographics of a Used Bookstore space and a Coffee Shop space and generate a coupon co-promotion that gives a discount on coffee for customers of the Coffee Shop space who donate or buy a used book at the Used Bookstore space.

As another example, an authorized user of a Sports Bar location account may indicate to the user interface system that they want to target customers in the 21-30 years old range that watch college basketball. The promotion engine 42 may analyze customer demographics data uploaded by other location accounts and determine that a local Gym space has frequent customers of that target demographic. The promotions engine 42 may suggest a co-promotion that gives members of the local Gym space a discount at the Sports Bar space during college basketball games by showing their Gym membership.

As another example, the promotion engine 42 may determine that five nearby physical spaces 30 have related customer demographics and/or products and services. The promotion engine 42 may suggest a group membership co-promotion to the five nearby physical spaces 30 that gives customers who join the group membership co-promotion discounts for shopping at the affiliated spaces.

As another example, the promotion engine 42 may determine a space similarity between Bar physical spaces 30 located in different states. The promotion engine 42 may suggest a co-promotion between each of those Bar physical spaces 30 for a “Bar Crawl across America” that incentivizes customers to travel to each state to visit the affiliated Bar spaces.

As another example, the promotion engine 42 may generate a limited time pop-up co-promotion event for nearby spaces with similar products and services. For example, the promotion engine 42 may generate a “Dumpling Week” pop-up co-promotion event to the restaurant physical spaces 30 located in nearby geolocations 32.

As another example, the promotion engine 42 may determine that two physical spaces 30 have similar customer demographics. The promotion engine 42 may generate a “sister” or “brother” space co-promotion between the two physical spaces 30. The user interface system 16 may provide a digital common space that allows customers of either sister space to post and communicate with each other. After linking two or more spaces as “sister” or “brother” spaces, the promotion engine 42 may further generate a competitive or cooperative co-promotion event between the sister spaces. In one example, the promotion engine 42 may suggest a limited time charity co-promotion event where a portion of proceeds go to charity. The user interface system 16 may keep track of a score for each sister space that may be viewed by any of their customers.

It should be appreciated that the co-promotions 44 described above are merely exemplary, and that the promotion engine 42 may identify other types of similarities between the measured values 22 of other types of physical space parameters 24, and generate other kinds of co-promotions 44 not specifically described herein.

To measure and track the one or more physical space parameters 24, each physical space 30 may be equipped with a corresponding on-premise sensor 46 configured to detect measured values 22 for the physical space parameter 24 over time. Each on-premise sensor 46 may be configured to measure one or more of the physical space parameters 24. In one example, one or more of the on-premise sensors may be configured for wireless capability, and may individually send, to the server 12, a data stream indicating the measured values 22. In another example, each on-premise sensor 46 may be configured to communicate with an associated client computing device 14 for that physical space 30. In this example, the associated client computing device 14 may be configured to gather the measured values 22 of one or more physical space parameters 24 from each on-premise sensor 46 and send a data stream indicating the measured values 22 to the server 12. In one example, the measured values 22 for a physical space parameter 24 may be measured by a user and entered via an input device of the client computing device. For example, a user may enter data for a Store Layout physical space parameter to the client computing device 14. The on-premise sensors 46 may include a temperature sensor configured to sense temperature, a light sensor configured to sense ambient light intensity and/or wavelength, a microphone configured to sense sound and coupled to logic circuitry configured to identify patterns of music, depth cameras and RGB cameras configured to detect density of persons and customer demographics, point of sale sensors configured to detect point of sale data, clocks configured to detect store hours, day of year, and time of day, scanners configured to scan product codes and detect product types, depth cameras and RGB cameras configured to recognize display types and store layout. As other examples, the sensors may include gas detectors configured to detect atmospheric gas composition, vibration sensors configured to detect vibrations, depth cameras and RGB cameras and microphones configured to detect customer interactions with objects in the physical space and also configured to detect employee interactions with customers in the physical space.

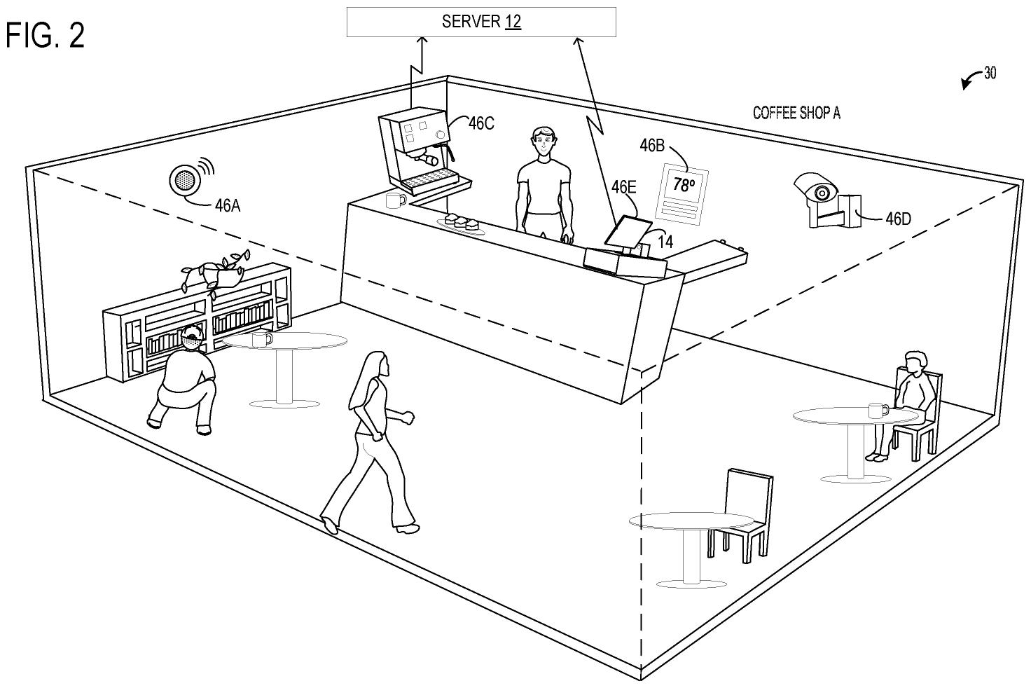

FIG. 2 illustrates an example physical space 30 for the Coffee Shop A illustrated in FIG. 1 having the Coffee Shop space type selected from the plurality of pre-defined space types 36. The example physical space 30 includes a plurality of on-premise sensors 46. In the illustrated example, the plurality of on-premise sensors 46 includes a music on-premise sensor 46A that is integrated into the speaker or a computer device that is streaming music to the speaker, a temperature on-premise sensor 46B that is integrated into the temperature control, an espresso flow rate on-premise sensor 46C that is integrated into the espresso machine, a camera on-premise sensor 46D that is integrated in the video camera device, and a point of service on-premise sensor 46E that is integrated in a point of service computing device. It will be appreciated that the illustrated on-premise sensors 46A-46E are merely exemplary, and that other types of on-premise sensors 46 may be used measure other types of physical space parameters 24.

In the illustrated example, the espresso flow rate on-premise sensor 46C is configured for wireless connectivity, and is itself configured to wirelessly stream its measured values 22 of an espresso flowrate physical space parameter 24 to the server 12 via a wireless network of the example physical space 30 (Coffee Shop A). In another example, the espresso flow rate on-premise sensor 46C may instead be configured to stream the measured values 22 to the client computing device 14, which, in this specific example, may be integrated in the point of sale computing device. The client computing device 14 may similarly receive steams of data of measured values 22 from each other on-premise sensor, including the music on-premise sensor 46A, the temperature on-premise sensor 46B, the camera on-premise sensor 46D, and the point of service on-premise sensor 46E. An authorized user of a location account 28 associated with the Coffee Shop A physical space may also enter measured values 22 for other physical space parameters 24, such as selecting a store layout physical space parameter. In the illustrated example, the authorized user may indicate that the store layout includes a bookcase having a plurality of books. In another example, the store layout physical parameter may be measured via the camera on-premise sensor 46D using image analysis techniques and methods.

The client computing device 14 may be configured to gather all of these streams of measured values 22 from each on-premise sensor 46, and upload the measured values 22 to the server 12 via the user interface system 16. In one example, the client computing device 14 may execute a client application program, such as a browser, configured to utilize the functionality of the API 40 of the user interface system 16 to appropriately stream the measured values gathered by the client computing device 14 to the server 12. The streaming of the measured values may be a continuous transmission of values in real-time or near real-time, or may be a periodic or occasional transmission of a batch of measured values.

In one example, the measured values 22 of the one or more physical space parameters 24 may be selectively shared by the client computing device 14 to the server 12. For example, the user of the Coffee Shop A physical space 30 may not want to share precise Point of Sale data, or may not want to share their data with the rival Coffee Shop B physical space across the street, and may select sharing permissions for each of a data type and resolution of data, as appropriate. In this way, a user may set sharing permissions for space, for example, to share density of customers data but not sales receipts data, with the density of customers data being shared at 0-25, 25-50, and more than 50 person resolution, as one example.

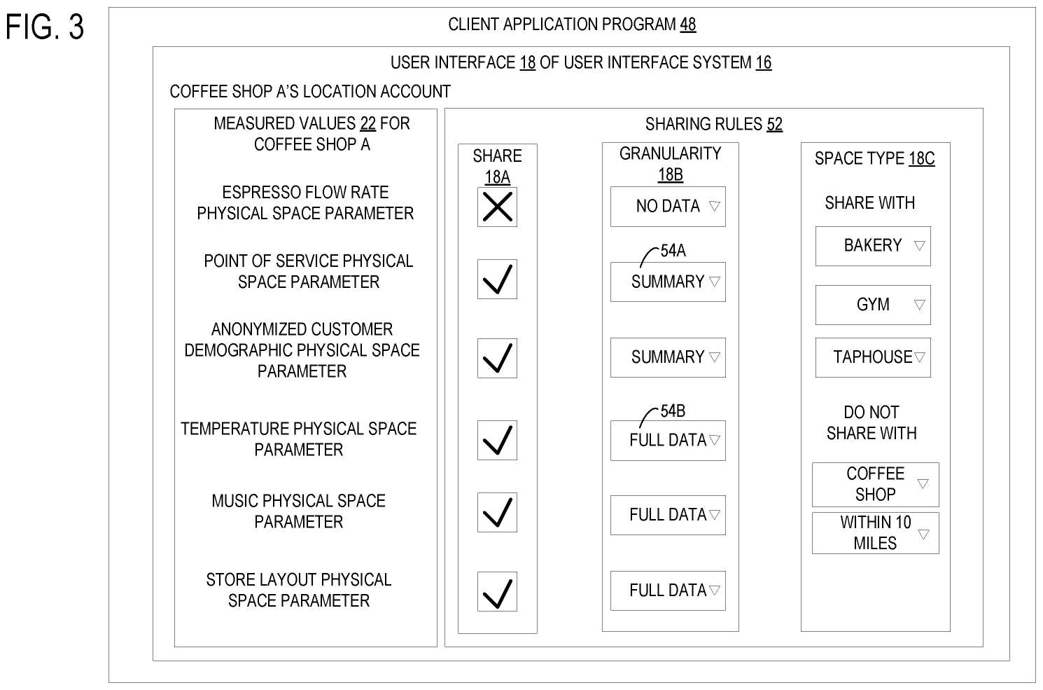

FIG. 3 illustrates an example user interface system 16 accessed by a client application program 48 executed on a client computing device 14, via which an authorized user for a location account 28 can selectively choose whether to share the measured values 22 or a summary thereof with other location accounts 28 via the user interface system 12. For example, an authorized user for the Coffee Shop A physical space may want to selectively share the measured values 22 from the on-premise sensors 46 with only physical spaces 30 that are not rival Coffee Shops. In another example, the authorized user may want to share the measured values 22 with the rival Coffee Shop B only if they reciprocate. In these examples, the authorized user may select appropriate sharing settings via the user interface 18 of the user interface system 16 via user input 20 entered to an input device of the client computing device 14.

As shown in FIG. 1, each location account 28 has an associated sharing profile 50 set by the authorized user for that location account 28, the sharing profile 50 defining a sharing rule 52 according to which the measured values 22 of the physical space parameter 24 are shared via the user interface system 16 with other location accounts 28. In one example, settings for the sharing rule may be adjusted by the authorized user for the location account 28 via the user interface 18 of the user interface system 16. FIG. 3 illustrates an example user interface 18 of the user interface system 16 which includes various GUI elements configured to receive the user input 20 from the plurality of client computing devices 14. Using the GUI elements of the example user interface 18, the authorized user for a location account 28 may selectively adjust the sharing rules 52 for the measured data 22 gathered by the on-premise sensors 46 of the physical location 30 for that location account 28.

In the example illustrated in FIG. 3, the sharing rule 52 includes one or more physical space parameters selected from a plurality of physical space parameters 24 that are shared via the user interface system 16 with other location accounts 28, and one or more physical space parameters selected from the plurality of physical space parameters 24 that are not shared. In the illustrated example, each category of measured values 22 gathered by the suite of on-premise sensors 46 of the Coffee Shop A physical space are shown. Using the share GUI element 18A of the user interface 18, the authorized user of the location account 28 associated with the Coffee Shop A physical space 30 may select one or more physical space parameters that may be shared via the user interface system 16 and one or more physical space parameters that may not be shared. In the illustrated example, the authorized user has selected that measured values 22 for the Point of Service physical space parameter, the anonymized customer demographic data physical space parameter, the temperature physical space parameter, the music physical space parameter, and the store layout physical space parameter maybe shared with other location accounts 28 via the user interface system 16. On the other hand, the authorized user has also selected that measured values 22 for the espresso flow rate physical space parameter are not to be shared with out location accounts 28. In this manner, the authorized user may enter user input 20 to the user interface 18 to selectively share measured values 22.

As further illustrated in FIG. 3, the authorized user may also set other types of sharing rules 52 that further define how the measured values 22 gathered by the corresponding on-premise sensors 46 may be shared with out location accounts 28. In one example, the sharing rules 52 include a sharing granularity 54 at which the measured values 22 of the physical space parameter 24 are shared via the network portal 16 with other location accounts 28. In the illustrated example, the authorized user may enter user input 20 to a sharing granularity GUI element 18B which may include a drop down menu for each measured physical space parameter 30. Using the sharing granularity GUI element 18B, the authorized user may select a sharing granularity 54 at which the measured values 22 for each measured physical space parameter 30 may be shared. In this example, the user may select between a summary sharing granularity 54A and a full data sharing granularity 54B. The summary sharing granularity 54A may include sharing an average or range of measured values for the corresponding physical space parameter 24. On the other hand, the full data sharing granularity 54B may include sharing the full set of measured values 22 for the corresponding physical space parameter 24. While only two sharing granularity options are illustrated, it will be appreciated that any other suitable granularity may be utilized, such as, for example, a course vs fine granularity.

In another example, the sharing rule 52 may further includes selecting one or more of the plurality of pre-defined space types 36 such that the measured values 22 of the physical space parameter 24 are not shared with location accounts 28 associated with the one or more of the plurality of pre-defined space types selected by the authorized user. In the illustrated example of FIG. 3, the authorized user may enter user input 20 to the space type GUI element 18C which may include one or more dropdown menus where the user may whitelist or blacklist certain physical space types for sharing. In the illustrated example, the authorized user for the Coffee Shop A has explicitly whitelisted the Bakery space type, the Gym space type, and the Tap House space type for data sharing. On the other hand, the authorized user has explicitly blacklisted the Coffee Shop space type such that the measured values 22 of the physical space parameters 24 gathered by the on-premise sensors 46 of the Coffee Shop A physical space are not shared with any other location accounts 28 associated with the Coffee Shop space type. Thus, in the example of FIG. 1, Coffee Shop A's measured values will be shared via the network portal 16 with the nearby Bakery, Tap House, and Gym, and may potentially be shared with the local library as well. On the other hand, Coffee Shop A's measured values will not be shared with Coffee Shop B.

It will be appreciated that the sharing rules 52 may include other types of rules. For example, the sharing rules 52 may further include a distance threshold for which the measured values 22 will be or not be shared. In the example illustrated in FIG. 3, the authorized user has selected that the measured values 22 will specifically not be shared with location accounts 28 that are both associated with the Coffee Shop space type and that are within ten miles. Thus, the measured values 22 may potentially be shared with location accounts 28 associated with the Coffee Shop space type that are farther than ten miles away, and are thus less likely to be competing stores. In one example, the promotion engine 42 may be configured to only generate co-promotions between location accounts 28 that have been authorized to share data with each other via the sharing rules 52.

It will be appreciated that the illustrated user interface 18 and the various GUI elements described above are merely exemplary, and that other configurations and GUI elements may be utilized to receive user input and perform the functionality described above.

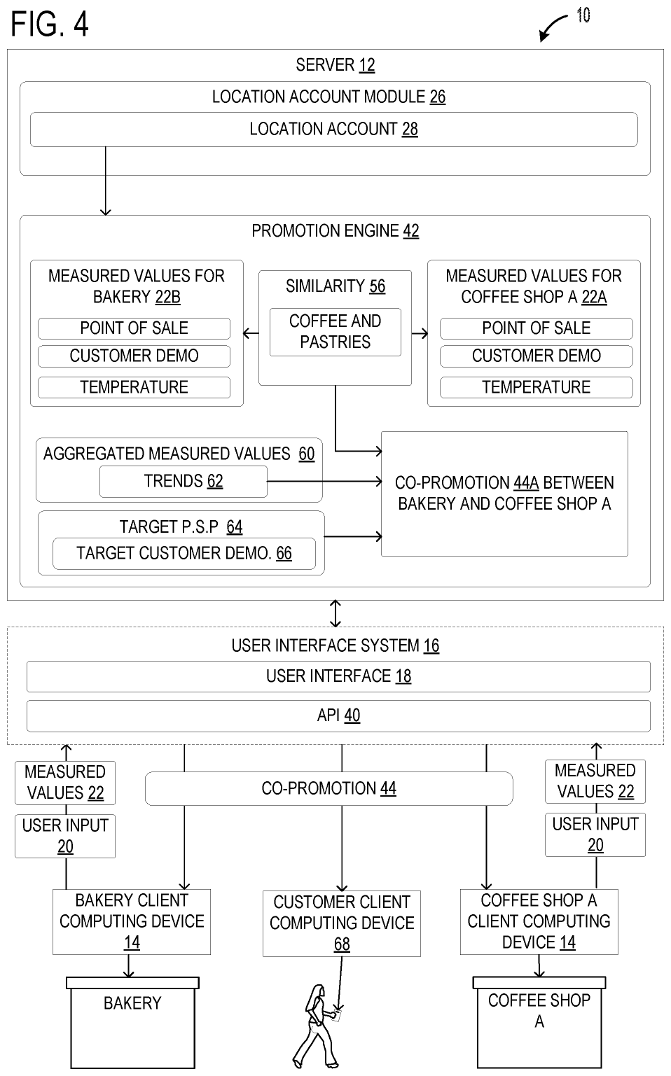

Turning to FIG. 4, after the authorized user for a location accounts as set up the sharing profile 50 for their associated location account 28 and has begun streaming measured values 22 of physical space parameters 24 to the server 12, the promotion engine 42 may compare their measured values 22 with other location accounts to identify similarities 56. In the specific example illustrated in FIG. 4, both the Bakery and the Coffee Shop A physical spaces have uploaded measured values 22 of physical space parameters 24 to the server 12, including values for point of sale data, customer demographics data, and temperature data. The promotion engine 42 compares the measures values 22A for the Coffee Shop A to the measured values 22B for the Bakery and determines one or more similarities 56 between the measured values of the various physical space parameters.

In the illustrated example, the promotion engine 42 determines that both the Bakery and the Coffee Shop A sell coffee and pastry product types, and have similar customer demographics. Further, as the Bakery and Coffee Shop A physical spaces have different space types 34, the promotion engine 42 may determine that a co-promotion 44 opportunity exists between the Bakery and the Coffee Shop A. For example, the promotion engine 42 may generate a co-promotion 44 between the Bakery and Coffee Shop A that includes a mutual discount where customers that buy coffee at Coffee Shop A get a discount on pastries bought at the Bakery, and customers that buy pastries at the Bakery get a discount on coffee bought at Coffee Shop A.

The promotion engine 42 may be configured to identify co-promotion 44 opportunities based on other factors. For example, the promotion engine 42 may be configured to aggregate the measured values 22 of each physical space parameter 24 from the plurality of location accounts 28 into the aggregated measured values 60. The promotion engine 42 may be configured to perform analysis on the aggregated measured values 60 to determine a trend 62 associated with measured values 22 of the physical space parameter 24 for the plurality of location accounts 28 and generate co-promotions based on the determined trend 62. The promotion engine 42 may utilize the determined trends 62 when identifying similarities 56 between measured values 22 of the physical space parameters 24 uploaded by two or more location accounts 28. As a specific example, the promotion engine 42 may determine, based on the aggregated measured values 60, that a trend 62 exists that customers that buy coffee products typically also buy pastry products. Thus, even though the Bakery physical space 30 may only sell pastries, and the Coffee Shop A physical space 30 may only sell coffee, the promotion engine 42 may determine that there is a similarity 56 between the products of the two physical spaces based on the identified trend 62 that people who buy coffee also buy pastries. It should be appreciated that other types of trends 62 may be identified by the promotion engine 42 and utilized to generate co-promotions 44.

In one example, authorized users for location accounts 28 may want to target specific types of businesses, customer demographics, products and services, and other characteristics of physical spaces, for their co-promotions 44. The computer system 10 may be configured to generate co-promotions 44 based on target parameters specified by authorized users for the location accounts 28 in addition to the identified similarities 56. For example, the promotion engine 42 may be configured to generate the co-promotion 44 for the location account 28 based on an input of a target physical space parameter 64 received from the authorized user via the user interface system 16. For example, an authorized user for a location account 28 may enter input to the user interface 18 of the user interface system 16 of a target physical space parameter 64, such as, for example, a target customer demographic 66, that the authorized user wants the co-promotions 44 to target. As a specific example, the authorized user of the Coffee Shop A location account 28 may have recently acquired soy milk, coconut milk, and other vegan options that can be mixed into their coffee products, and want to promote their new vegan options to a target customer demographic 66 of vegans. Based on the target customer demographic 66, the promotion engine 42 may identify that the measured values 22B for the Bakery location account 28 indicates that they frequently sell vegan pastries. Thus, the promotion engine 42 may generate a co-promotion 44 between the Bakery that sells vegan pastries and the Coffee Shop A that wants to target vegan customers.

It should be appreciated that other types of target physical space parameters 64 may be entered by authorized users and used when generating co-promotions 44. For example, the target physical space parameter 64 may include a particular time of day that an authorized user of a location account 28 wants to drive additional customers to their physical space 30. That is, a restaurant physical space may have too many customers at 5:00 P.M., but too few customers at 9:00 P.M. On the other hand, a bar physical space may have too many customers at 9:00 P.M., but too few customers at 5:00 P.M. Thus, the authorized users of the restaurant and bar may enter target physical space parameters 64 for the corresponding periods of time that they have too few customers. Based on the target periods of time, and measured values 22 for a customer density physical space parameter uploaded by the restaurant and bar physical spaces, the promotion engine 42 may generate a happy hour co-promotion between the location accounts for the restaurant and bar physical spaces. For example, at 5:00 P.M., the restaurant physical space may present a promotion to their customers that the bar physical space is having a happy hour. In return, at 9:00 P.M., the bar physical space may present a promotion to their customers that the restaurant physical space is having a happy hour. In this manner, the bar and restaurant physical spaces may co-promote each other to drive their excess customers to each other in a mutually beneficial manner.

The co-promotions 44 described above may be served to customers of the physical spaces 30 participating in the co-promotion 44 via several different mediums. In one example, the application programming interface (API) 40 of the user interface system 16 is further configured to interface with the promotion engine 42 of the server 12. The API 40 is callable by a point of sale system associated with the location account 28, such as the point of sale on-premise sensor 46E, to provide the point of sale system with the accepted co-promotion 44. The point of sale system may print details for the co-promotion 44 on receipts of their customers. Other client computing devices 14 may also call the API 40 to retrieve any currently active co-promotions 44 for a physical space 30. For example, the authorized user of the location account may use the API 40 to email the co-promotion 44 to their customers, print out details for the co-promotion 44, or otherwise communicate the co-promotion 44 to their customers.

In another example, the API 40 is further callable by customer client computing devices 68, such as a mobile computing device including a smart phone, a tablet, a wearable computing device, etc. For example, the client application program 48 may also be installed on customer client computing devices 68. While the customer users may not be authorized users for the plurality of location accounts 28, the customer users may access details for co-promotions between physical spaces 30 via the client application program 48 executed on the customer client computing device 68. In this example, the client application program 48 executed on the customer client computer device 68 may be configured to detect that a user of the customer client computer device 68 is located at the physical space 30 associated with the location account 28. For example, if allowed via user privacy settings, the client application program 48 may access geolocation data for the customer client computer device 68 while the user is currently running the client application program 48. The client application program 48 may call the API 40 to retrieve relevant co-promotions 44. In this example, the client application program 48 may send the geolocation data to the server 12, which may be configured to determine which physical space 30 is near the user. Based on the user's geolocation, the promotion engine 42 may be configured to determine whether the location account 28 for the determined physical space 30 currently has any active co-promotions 44. If there are active co-promotions, the user interface system 16 may be configured to present the co-promotion 44 associated with the location account 28 to the user via the client application program 48.

In one example, presenting the co-promotion 44 to the user of the client application program 48 includes displaying the details of the co-promotion 44 to the user, and keeping track of whether the user of the customer client computer device 68 has fulfilled promotion parameters of the co-promotion 44. As a specific example, if the co-promotion 44A between the Bakery and the Coffee Shop A shown in FIG. 4 requires a customer to purchase a product from one of the physical spaces 30 before getting a discount to products at the other physical space 30, then the client application program 48 may be configured to keep track of whether the user has purchased a product at the Bakery or the Coffee Shop A. For example, the client application program 48 may be configured to receive a confirmation from the point of service system of one of the physical spaces 30 before allowing the discount to be applied to a purchase at the other physical space. As another example, the co-promotion 44 may only require the user to visit one of the physical spaces 30 to receive the benefits of a co-promotion 44 at another associated physical space 30 that is also participating in the co-promotion 44. In this example, the client application program 48 may keep track of the whether the user has fulfilled promotion parameters of the co-promotion based on the user's detected geolocation. As another example, the co-promotion 44 may require the user to join a group membership, such as a loyalty membership application, before the user receives discounts to the affiliated physical spaces 30. In this example, the client application program 48 may track whether the user has joined the group membership. It should be appreciated that other kinds of promotion parameters not mentioned above may also be tracked by the client application program 48.

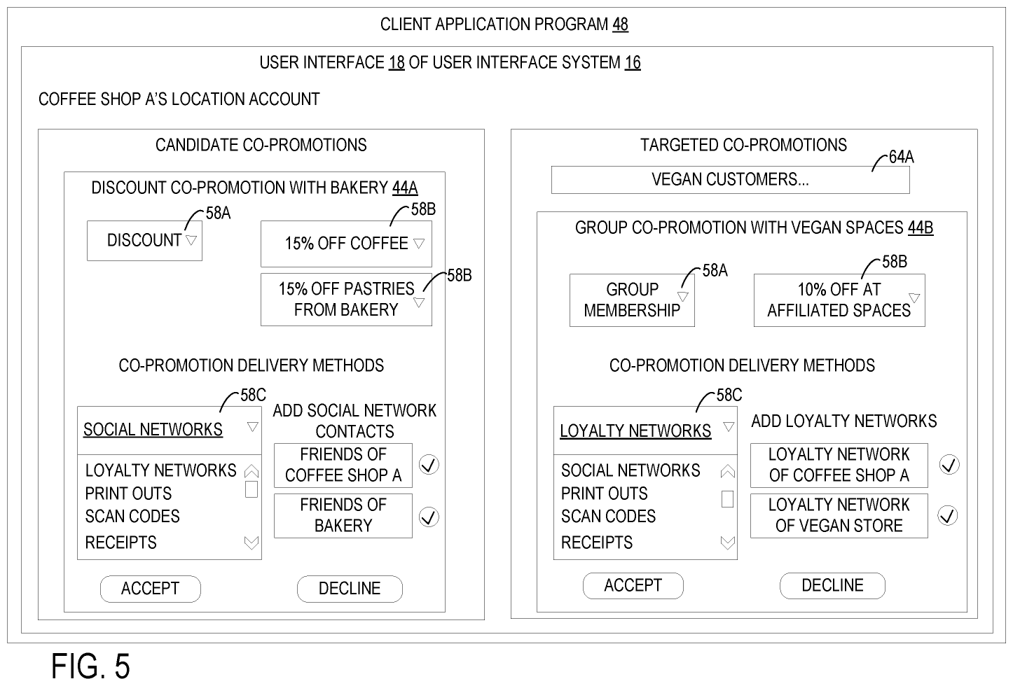

FIG. 5 illustrates an example user interface 18 of the user interface system 16 accessed by a client application program 48 executed on a client computing device 14, via which an authorized user for a location account 28 can view and accept a co-promotion 44 between the location account 28 and one or more other location accounts generated by the promotion engine 42. In the illustrated example, the Coffee Shop A location account currently has the co-promotion 44A with the Bakery generated by the promotion engine 42 in the example illustrated in FIG. 4. The authorized user for the Coffee Shop A may view the co-promotion 44A via the user interface 18 of the user interface system 16. The user interface 18 may include GUI elements for the authorized user to accept or decline a candidate co-promotion, such as, for example, the co-promotion 44A with the Bakery. In this example, a candidate co-promotion between two or more location accounts 28 is not activated until authorized users for each of the two or more location accounts 28 have accepted the co-promotion. Acceptance of the candidate co-promotion may occur asynchronously. For example, the authorized user of the Coffee Shop A location account may accept the co-promotion 44A with the Bakery. However, the co-promotion 44A will not be activated until an authorized user for the Bakery location account also accepts the co-promotion 44A.

In one example, the user interface 18 of the user interface system 16 may also include GUI elements configured to receive user input from authorized users for each of the two or more locations accounts 28 to change a promotion parameter 58 of the candidate promotion. In the illustrated example, the promotion parameters 58 may include a co-promotion type 58A. For example, the co-promotion type 58A may include a discount or coupon, an advertisement, a limited time event, a “sister” or “brother” space, a group membership such as a loyalty card, etc. Specific examples of these co-promotion types 58A are described above with reference to FIG. 1. The promotion parameters 58 may also include a discount value 58B that specifies how much certain products or services sold by the businesses of the two or more location accounts affiliated with be co-promotion 44 will be discounted. The discount value 58B may be applied to specific products or services, or may be applied to all products or services provided by the affiliated location accounts 28.

In one example, the promotion parameters 58 may also include a co-promotion delivery method 58C that specifies how the candidate co-promotion may be delivered to customers of the participating physical spaces 30. In the example illustrated in FIG. 5, the authorized user for the Coffee Shop A location account has selected that the candidate co-promotion 44A with the Bakery will be delivered to customers that are connected to the Coffee Shop A or Bakery via a social network. For example, the authorized user for the Coffee Shop A may specify a list of friends, followers, contacts, etc., associated with their social network account, and the server 12 may be configured to send the candidate co-promotion to contact address associated with the specified list. Similarly, the authorized user for the Bakery location account may also specify a list of friends associated with their own social network accounts. The members of the specified lists may opt-in or out of receiving co-promotions.

As illustrated in FIG. 5, the co-promotion delivery methods 58C may also include loyally networks, print outs, scannable codes, receipts, and other mediums to deliver the co-promotions to customers. Similarly to the social network example, authorized users may specify loyally networks that include contact information for customers that have joined those loyalty networks. These customers may opt-in or out of receiving co-promotions via the loyalty networks. Print-outs may include printable media such as posters, stickers, etc., that may include the details of the candidate co-promotion accepted by the participating parties. The client application program 48 may also be configured to interface with the point of sale system of the physical space 30, and may be configured to cause the point of sale system to print the co-promotion 44 on purchase receipts. In one example, the user interface system 16 may be configured to generate scannable codes associated with each co-promotion 44. The scannable codes may be printed on the print-outs, receipts, coupons, or shown electronically via a website, email, application program, etc. Customers' client computer devices 68 may access co-promotions 44 using the associated codes via the user interface system 16 or the client application program 48 installed on the customer client computer devices 68. The co-promotions 44 are not limited to the delivery methods discussed above, and may be delivered to customers via any suitable medium or delivery method.

It should be appreciated that other types of promotion parameters 58 not shown in FIG. 5 may also be selected and changed via the user interface 18 of the user interface system 16. For example, a promotion parameter 58 specifying a type of advertisement for the co-promotion 44, such as, for example, an online advertisement, a physical poster advertisement, etc. As another example, the promotion parameters 58 may include a period of time parameter that specifies a duration of time that the co-promotion 44 will be valid, or a schedule for the co-promotion. For example, a happy hour co-promotion may include a period of time parameter that specifies that the co-promotion is valid from 4:00 P.M. to 5:00 P.M.

After an authorized user of a location account participating in the co-promotion 44 has changed a promotion parameter 58, the updated co-promotion 44 may be presented to authorized users of the other location accounts that are also participating in the co-promotion 44. In this manner, each authorized user may make changes to various promotion parameters 58 until all parties are satisfied with the terms of the candidate co-promotion. Once each of the authorized users of the participating location accounts has accepted the candidate co-promotion, the server 12 may be configured to activate the co-promotion. In this manner, authorized users of multiple location accounts 28 may negotiate the terms of the co-promotion 44 using user interface 18 of the user interface system 16 of the computer system 10.

As described regarding FIG. 4, an authorized user of a location account 28 may input a target physical space parameter 64 to the user interface 18 of the user interface system 16. In the example illustrated in FIG. 5, the target physical space parameter 64 is a customer demographic of vegan customers 64A. The target physical space parameter 64 may be sent to the promotion engine 42, which in turn may be configured to generate a co-promotion 44 based on at least the target physical space parameter 64. In the illustrated example, the promotion engine 42 may determine that a plurality of location accounts 28 have input a target physical parameter 64 of the vegan customer demographic 64A, and generates a co-promotion 44B for the plurality of location accounts for a group membership co-promotion. The authorized user's of the affiliated location accounts 28 may negotiate the promotion parameters 58 as discussed above, and either accept or decline the co-promotion 44B. After accepting the co-promotion 44B of a group membership promotion, the co-promotion 44B becomes active and may be presented to customers of any of the affiliated physical spaces 30.

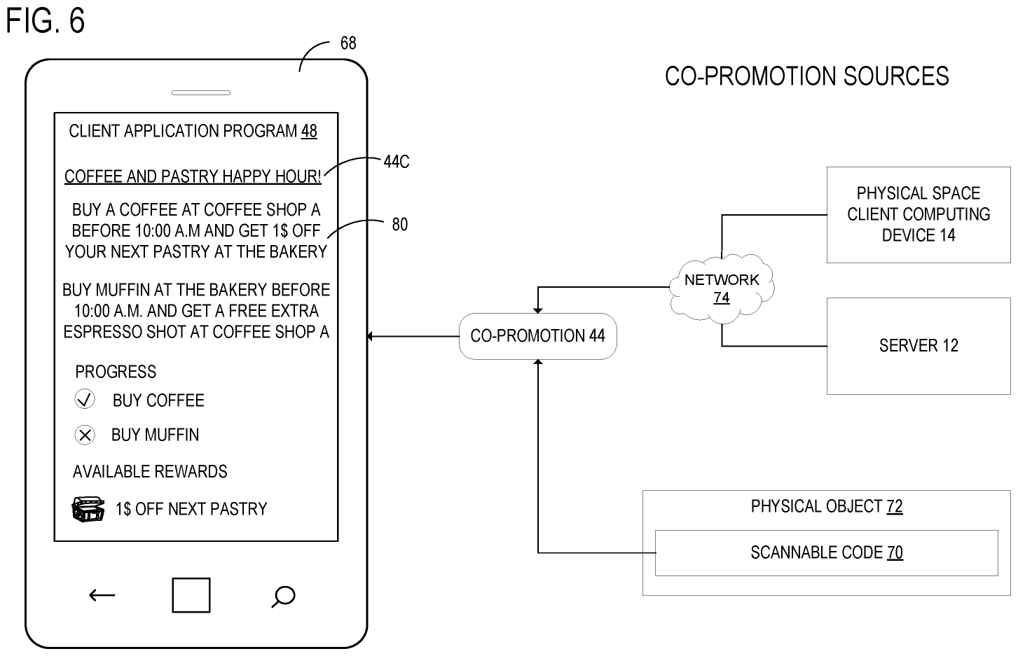

FIG. 6 illustrates an example co-promotion 44C being presented to a customer via the customer client computing device 68. The example co-promotion 44C is presented on a display of the customer client computing device 68 though the client application program 48 installed on the customer client computing device 68. In one example, the client application program 48 may access the example co-promotion 44C by taking a picture of a scannable code 70 on a physical object 72. As discussed above, the server 12 may be configured to generate the scannable code 70 that is associated with the example co-promotion 44C. The scannable code 70 may then be printed on or attached to physical objects 72, such as posters, receipts, physical coupons, etc. However, the scannable code 70 may also be provided electronically, such as, for example, through a website, email, application program, etc. After retrieving the scannable code 70, the client application program 48 may query the server 12 over a network 74 with the scannable code 70, and receive details for the co-promotion associated with the code.

In another example, the client application program 48 may be configured to determine a geolocation of the customer client computer device 68, and send the determined geolocation to the server 12. The server 12 may be configured to determine which physical space 30 the customer is located in based on the detected geolocation. The server 12 may then determine an associated location account for that physical space 30, and send a co-promotion 44 that is active for the associated location account. In another example, the client computing device 14 of the physical space 30 that the customer is located in may send the co-promotion 44 to the client application program 48 installed on the customer's client computing device 68 over a network 74, which may be a wireless network. In another example, the server 12 may send the co-promotion 44 to the contact addresses specified in the social networking and/or loyalty networks discussed with regard to FIG. 5. If the user of the customer client computing device 68 has opted into receiving co-promotions, and is a member of the specified social networks and/or loyally networks, the customer's client computing device 68 may receive the co-promotion 44 for display to the user.

The example co-promotion 44C illustrated in FIG. 6 is a discount/happy hour co-promotion between the Coffee Shop A physical space and the Bakery physical space. The example co-promotion 44C includes a description 80 of the terms and conditions of the co-promotion. As discussed above, the client application program 48 may also be configured to track whether the customer has fulfilled promotion parameters of the co-promotion. In the illustrated example, the promotion parameters include a one dollar discount on the next pastry if the customer buys a coffee at Coffee Shop A. The promotion parameters also include a free extra espresso shot if the customer buys a muffin at the Bakery. The client application program 48 may detect whether the customer has fulfilled either of these promotion parameters. For example, the client application program 48 may be configured to receive a message from the point of service system of the physical space 30 when the customer purchases a coffee at the Coffee shop A or a Muffin at the Bakery. In some examples, the co-promotion may only require the customer to visit certain physical spaces 30 that are participating in the co-promotion. In this example, the client application program 48 may detect that the customer has visited those physical spaces based on a detected geolocation of the customer's client computing device 68, by detecting a wireless network associated with the physical space, or another suitable method. It should be appreciated that other methods of tracking whether the customer has fulfilled the promotion parameters may also be utilized.

In the example illustrated in FIG. 6, the customer has currently fulfilled the promotion parameter of buying a coffee at the Coffee Shop A. After detecting that the customer has bought a Coffee, the client application program 48 determines that the pastry discount at the Bakery is now valid for the customer. The client application program 48 may then keep track of when the customer redeems the discount at the Bakery. In the illustrated example, the customer has not yet bought a muffin at the Bakery. Thus, the client application program 48 has tracked that the customer has not fulfilled the muffin promotion parameter and determines that the customer is not eligible for the free espresso shot at the Coffee Shop A physical space. It should be appreciated that the example co-promotion 44C illustrated in FIG. 6 is merely exemplary, and that the co-promotions may take other suitable forms, as described above.

According to the processes described above, co-promotions 44 between two or more location accounts may be automatically generated based on uploaded measured data 22 of physical space parameters 24, identified trends 62, and target physical space parameters 64 entered by authorized users of the location accounts 28. Using the user interface system 16 of the computer system 10, the authorized users of location accounts 28 participating in a particular co-promotion 44 may change various promotion parameters 58 until all participating parties are satisfied with the co-promotion 44. After a co-promotion 44 has been accepted by the participating parties, the computer system 10 may present the co-promotions to customers of the participating parties via different mediums.

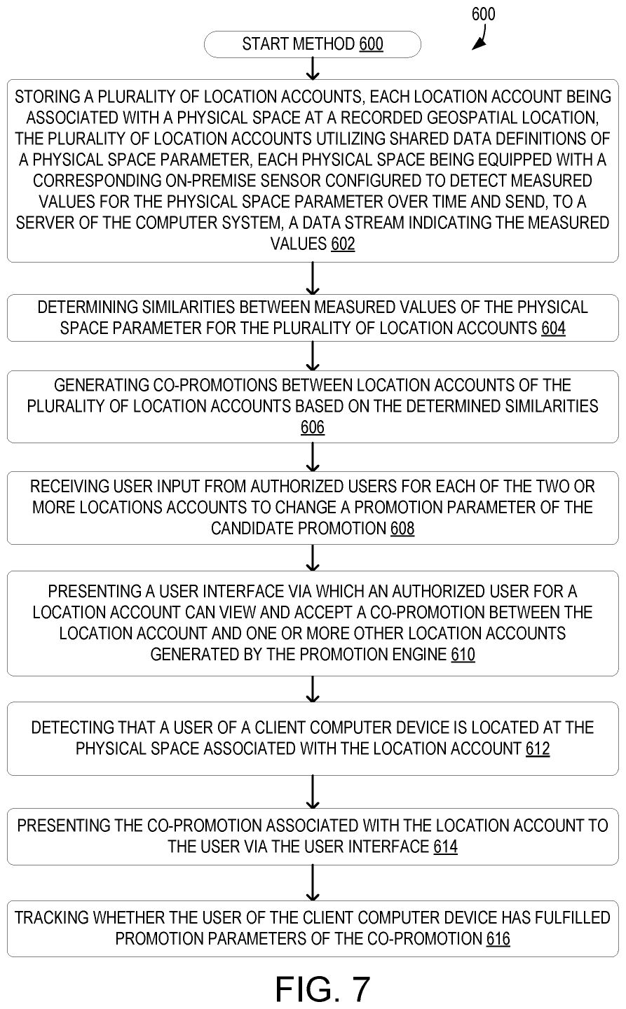

FIG. 7 is a flow chart of a method that may be implemented by the computer system 10. Method 600 may be executed using the systems described above or utilizing other suitable hardware and software elements.

At 602, the method 600 may include, at a computer system including one or more processors, storing a plurality of location accounts, each location account being associated with a physical space at a recorded geospatial location, the plurality of location accounts utilizing shared data definitions of a physical space parameter, each physical space being equipped with a corresponding on-premise sensor configured to detect measured values for the physical space parameter over time and send, to a server of the computer system, a data stream indicating the measured values. The physical space parameters detected by the on-premise sensors may include temperature, lighting, music, density of persons, customer demographics, point of sale data, store hours, day of year, time of day, product types, display types, store layout, atmospheric gas composition, wavelengths of ambient light, vibration, customer interactions with objects, and employee interactions with customers. FIG. 2 illustrates an example physical space 30 that is instrumented with a plurality of different on-premise sensors 46 configured to detect different physical space parameters.

At 604, the method 600 may include determining similarities between measured values of the physical space parameter for the plurality of location accounts. As a specific example, by comparing measured values for a customer demographics physical space parameter between a first and second location account, the computer system implementing method 600 may determine that the first and second location accounts have similar customer demographics. That is, the type of customer that patronizes the physical space of the first location account also patronizes the physical space of the second location account. Other similarities among products and services provided, temperature, mood, lighting, music, and other physical space parameters may be identified at step 604.

At 606, the method 600 may include generating co-promotions between location accounts of the plurality of location accounts based on the determined similarities. FIG. 4 illustrates an example co-promotion that was generated based on a similarity in the products sold by a Coffee Shop and a Bakery. In one example, the co-promotion may be further generated based on an input of a target physical space parameter received from an authorized user via a user interface. The target physical space parameter may include a target customer demographic. However, it should be appreciated that any of the physical space parameters discussed above with regard to FIG. 1 and FIG. 2 may also be specified as a target physical parameter. In another example, step 606 may include determining a trend associated with measured values of the physical space parameter for the plurality of location accounts and generating co-promotions based on the determined trend. As a specific example, the method 600 may include aggregating the measured values of the physical space parameters into aggregated measured values. Based on the aggregated measured values, the computer system implementing the method 600 may, for example, identify that a trend exists that customers that buy coffee products typically also buy pastry products. Thus, even though a bakery may only sell pastries, and coffee shop may only sell coffee, the computer system may determine that there is a similarity between the products of the two physical spaces based on the identified trend that people who buy coffee also buy pastries.

At 608, the method 600 may include receiving user input from authorized users for each of the two or more locations accounts to change a promotion parameter of the candidate promotion. As described with reference to FIG. 5, an authorized user of a location account may enter inputs to a user interface system to change promotion parameters of any currently pending co-promotions associated with their location account. These changes promotional parameters may include a co-promotion type such as a discount or coupon, an advertisement, a limited time event, a “sister” or “brother” space, a group membership such as a loyalty card, etc. Specific examples of these co-promotion types 58A are described above with reference to FIG. 1. The promotion parameters 58 may also include a discount value 58B that specifies how much certain products or services sold by the businesses of the two or more location accounts affiliated with he co-promotion 44 will be discounted. It should be appreciated that other types of promotion parameters may also be changeable such that the authorized users may negotiate the terms and conditions of the co-promotions.

At 610, the method 600 may include presenting a user interface via which an authorized user for a location account can view and accept a co-promotion between the location account and one or more other location accounts generated by the promotion engine. FIG. 5 illustrates an example user interface 18 of a user interface system 16 of the computer system implementing the method 600. The user interface 18 includes various GUI components configured to present the details of a currently pending co-promotion associated with the authorized user's location account. Using the GUI components, the authorized user may select to accept or decline each pending co-promotion. In one example, a candidate co-promotion between two or more location accounts is not activated until authorized users for each of the two or more location accounts have accepted the co-promotion. Co-promotions may be accepted asynchronously by the authorized users of the participating location accounts.

At 612, the method 600 may include detecting that a user of a client computer device is located at the physical space associated with the location account. In one example, to access the co-promotions, customers may install a client application program on their client computing devices that is configured to communicate with the user interface system of the computer system 10. If allowed via privacy settings on the user's client computing device, the client application program may detect the user's current geolocation when the client application program is running, and send the user's current geolocation to the computer system 10. The computer system may be configured to compare the user's geolocation to the physical space's geolocation to determine whether the user is currently at the physical space. Alternatively, the physical space may include a Wi-Fi network, and the client application program may determine that the user is at the physical space based on detecting the Wi-Fi network. It should be appreciated that other methods of determining location may also be utilized.

At 614, the method 600 may include presenting the co-promotion associated with the location account to the user via the user interface. In the example shown in FIG. 4, the computer system includes an application programming interface callable by a point of sale system associated with the location account to provide the point of sale system with the accepted co-promotion. For example, the point of sale system may be configured to call the API to retrieve details of any currently active co-promotions, and print the details of the co-promotions on a receipt for an applicable customer. As another example, co-promotions may be pushed to a client application program installed on the client computing devices of customers who are currently located at a physical space participating in the co-promotion.

At 616, the method 600 may include tracking whether the user of the client computer device has fulfilled promotion parameters of the co-promotion. Client computing devices of customers may include a client application program that is configured to communicate with point of service systems of the various physical locations and the user interface system of the computer system implementing method 600. The client application program may be configured to track whether the customer has fulfilled the promotion parameters set at step 608 of the method 600. For example, the client application program may track whether the user purchased a product or service at a physical space associated with a co-promotion before allowing discounts at another physical space also participating in the co-promotion. In this manner, the method 600 may generate co-promotions between physical spaces, provide a platform for authorized users to negotiate the terms of the co-promotions for their physical space, and ensure that the agreed upon terms are fulfilled by customers before providing the benefits of the co-promotion, such as discounts.

In some embodiments, the methods and processes described herein may be tied to a computing system of one or more computing devices. In particular, such methods and processes may be implemented as a computer-application program or service, an application-programming interface (API), a library, and/or other computer-program product.

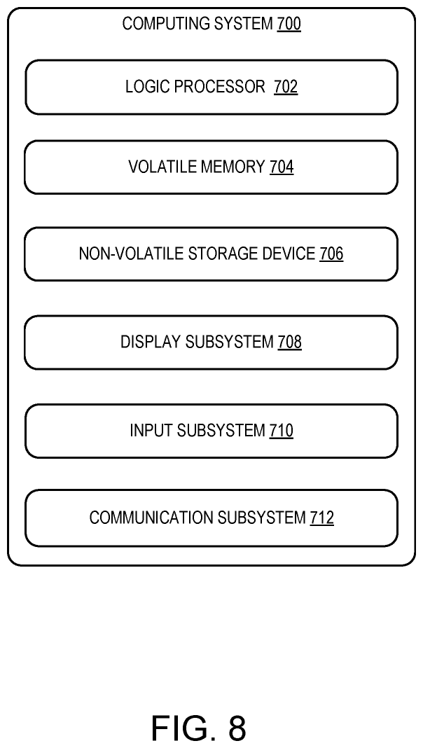

FIG. 8 schematically shows a non-limiting embodiment of a computing system 700 that can enact one or more of the methods and processes described above. Computing system 700 is shown in simplified form. Computing system 700 may embody the computer system 10 described above, including the server 12, the client computing devices 14, and a computer device implementing the user interface system 16, illustrated in FIG. 1. Computing system 700 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 700 includes a logic processor 702 volatile memory 704, and a non-volatile storage device 706. Computing system 700 may optionally include a display subsystem 708, input subsystem 710, communication subsystem 712, and/or other components not shown in FIG. 8.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the logic processors to implement the methods and processes described herein. When such methods and processes are implemented, the state of non-volatile storage device 704 may be transformed—e.g., to hold different data.

Non-volatile storage device 706 may include physical devices that are removable and/or built-in. Non-volatile storage device 704 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via logic processor 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 700 to send and/or receive messages to and/or from other devices via a network such as the Internet.

The following paragraphs provide additional support for the claims of the subject application. One aspect provides a computer system comprising a server configured to store a plurality of location accounts, each location account being associated with a physical space at a recorded geospatial location. The plurality of location accounts utilize shared data definitions of a physical space parameter. Each physical space is equipped with a corresponding on-premise sensor configured to detect measured values for the physical space parameter over time and send to the server a data stream indicating the measured values. The server includes a promotion engine configured to determine similarities between measured values of the physical space parameter for the plurality of location accounts and generate co-promotions between location accounts of the plurality of location accounts based on the determined similarities. The computer system further includes a user interface system, via which an authorized user for a location account can view and accept a co-promotion between the location account and one or more other location accounts generated by the promotion engine. In this aspect, additionally or alternatively, the physical space parameter may be selected from the group consisting of temperature, lighting, music, density of persons, customer demographics, point of sale data, store hours, day of year, time of day, product types, display types, store layout, atmospheric gas composition, wavelengths of ambient light, vibration, customer interactions with objects, and employee interactions with customers. In this aspect, additionally or alternatively, a candidate co-promotion between two or more location accounts may not be activated until authorized users for each of the two or more location accounts have accepted the co-promotion. In this aspect, additionally or alternatively, the user interface system may be further configured to receive user input from authorized users for each of the two or more locations accounts to change a promotion parameter of the candidate promotion. In this aspect, additionally or alternatively, the promotion engine may be further configured to generate the co-promotion for the location account based on an input of a target physical space parameter received from the authorized user via the user interface system. In this aspect, additionally or alternatively, the target physical space parameter may be a target customer demographic. In this aspect, additionally or alternatively, the promotion engine may be further configured to determine a trend associated with measured values of the physical space parameter for the plurality of location accounts and generate co-promotions based on the determined trend. In this aspect, additionally or alternatively, the promotion engine may include an application programming interface callable by a point of sale system associated with the location account to provide the point of sale system with the accepted co-promotion. In this aspect, additionally or alternatively, the computer system may further comprise a client application program executed on a client computer device configured to detect that a user of the client computer device is located at the physical space associated with the location account, wherein the user interface system may be further configured to present the co-promotion associated with the location account to the user via the client application program. In this aspect, additionally or alternatively, the client application program may be further configured to track whether the user of the client computer device has fulfilled promotion parameters of the co-promotion.

Another aspect provides a method comprising, at a computer system including one or more processors, storing a plurality of location accounts, each location account being associated with a physical space at a recorded geospatial location. The plurality of location accounts utilize shared data definitions of a physical space parameter. Each physical space is equipped with a corresponding on-premise sensor configured to detect measured values for the physical space parameter over time and send, to a server of the computer system, a data stream indicating the measured values. The method further comprises determining similarities between measured values of the physical space parameter for the plurality of location accounts, generating co-promotions between location accounts of the plurality of location accounts based on the determined similarities, and presenting a user interface via which an authorized user for a location account can view and accept a co-promotion between the location account and one or more other location accounts generated by the promotion engine. In this aspect, additionally or alternatively, a candidate co-promotion between two or more location accounts may not be activated until authorized users for each of the two or more location accounts have accepted the co-promotion. In this aspect, additionally or alternatively, the method may further comprise receiving user input from authorized users for each of the two or more locations accounts to change a promotion parameter of the candidate promotion. In this aspect, additionally or alternatively, the method may further comprise generating the co-promotion for the location account based on an input of a target physical space parameter received from the authorized user via the user interface. In this aspect, additionally or alternatively, the target physical space parameter may be a target customer demographic. In this aspect, additionally or alternatively, the method may further comprise determining a trend associated with measured values of the physical space parameter for the plurality of location accounts and generating co-promotions based on the determined trend. In this aspect, additionally or alternatively, the computer system may include an application programming interface callable by a point of sale system associated with the location account to provide the point of sale system with the accepted co-promotion. In this aspect, additionally or alternatively, the method may further comprise detecting that a user of a client computer device is located at the physical space associated with the location account, and presenting the co-promotion associated with the location account to the user via the user interface. In this aspect, additionally or alternatively, the method may further comprise tracking whether the user of the client computer device has fulfilled promotion parameters of the co-promotion.

Another aspect provides a computer system comprising a server configured to store a plurality of location accounts, each location account being associated with a physical space at a recorded geospatial location. The plurality of location accounts utilize shared data definitions of a physical space parameter. Each physical space is equipped with a corresponding on-premise sensor configured to detect measured values for the physical space parameter over time and send to the server a data stream indicating the measured values. The server includes a promotion engine configured to aggregate measured values of the physical space parameter for the plurality of location accounts and determine a trend associated with the aggregated measured values for the plurality of location accounts and generate co-promotions between two or more location accounts based on the determined trend. The computer system further includes a user interface system, via which an authorized user for a location account can view and accept a co-promotion between the location account and one or more other location accounts generated by the promotion engine.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computer system, comprising:
a server configured to store a plurality of location accounts, each location account being associated with a physical space at a recorded geospatial location, the plurality of location accounts utilizing shared data definitions of a physical space parameter, each physical space being equipped with a corresponding on-premise sensor configured to detect measured values for the physical space parameter over time and send to the server a data stream indicating the measured values;
wherein the server includes a promotion engine configured to determine similarities between measured values of the physical space parameter for the plurality of location accounts and generate co-promotions between location accounts of the plurality of location accounts based on the determined similarities; and
a user interface system, via which an authorized user for a location account can view and accept a co-promotion between the location account and one or more other location accounts generated by the promotion engine.

2. The computer system of claim 1, wherein the physical space parameter is selected from the group consisting of temperature, lighting, music, density of persons, customer demographics, point of sale data, store hours, day of year, time of day, product types, display types, store layout, atmospheric gas composition, wavelengths of ambient light, vibration, customer interactions with objects, and employee interactions with customers.

3. The computer system of claim 1, wherein a candidate co-promotion between two or more location accounts is not activated until authorized users for each of the two or more location accounts have accepted the co-promotion.

4. The computer system of claim 3, wherein the user interface system is further configured to receive user input from authorized users for each of the two or more locations accounts to change a promotion parameter of the candidate promotion.

5. The computer system of claim 1, wherein the promotion engine is further configured to generate the co-promotion for the location account based on an input of a target physical space parameter received from the authorized user via the user interface system.

6. The computer system of claim 5, wherein the target physical space parameter is a target customer demographic.

7. The computer system of claim 1, wherein the promotion engine is further configured to determine a trend associated with measured values of the physical space parameter for the plurality of location accounts and generate co-promotions based on the determined trend.

8. The computer system of claim 1, wherein the promotion engine includes an application programming interface callable by a point of sale system associated with the location account to provide the point of sale system with the accepted co-promotion.

9. The computer system of claim 1, further comprising a client application program executed on a client computer device configured to detect that a user of the client computer device is located at the physical space associated with the location account; and
wherein the user interface system is further configured to present the co-promotion associated with the location account to the user via the client application program.

10. The computer system of claim 9, wherein the client application program is further configured to track whether the user of the client computer device has fulfilled promotion parameters of the co-promotion.

11. A method comprising:
at a computer system including one or more processors:
storing a plurality of location accounts, each location account being associated with a physical space at a recorded geospatial location, the plurality of location accounts utilizing shared data definitions of a physical space parameter, each physical space being equipped with a corresponding on-premise sensor configured to detect measured values for the physical space parameter over time and send, to a server of the computer system, a data stream indicating the measured values;
determining similarities between measured values of the physical space parameter for the plurality of location accounts;
generating co-promotions between location accounts of the plurality of location accounts based on the determined similarities; and
presenting a user interface via which an authorized user for a location account can view and accept a co-promotion between the location account and one or more other location accounts generated by the promotion engine.

12. The method of claim 11, wherein a candidate co-promotion between two or more location accounts is not activated until authorized users for each of the two or more location accounts have accepted the co-promotion.

13. The method of claim 12, further comprising receiving user input from authorized users for each of the two or more locations accounts to change a promotion parameter of the candidate promotion.

14. The method of claim 11, further comprising generating the co-promotion for the location account based on an input of a target physical space parameter received from the authorized user via the user interface.

15. The method of claim 14, wherein the target physical space parameter is a target customer demographic.

16. The method of claim 11, further comprising determining a trend associated with measured values of the physical space parameter for the plurality of location accounts and generating co-promotions based on the determined trend.

17. The method of claim 11, wherein the computer system includes an application programming interface callable by a point of sale system associated with the location account to provide the point of sale system with the accepted co-promotion.

18. The method of claim 11, further comprising:
detecting that a user of a client computer device is located at the physical space associated with the location account; and
presenting the co-promotion associated with the location account to the user via the user interface.

19. The method of claim 18, further comprising tracking whether the user of the client computer device has fulfilled promotion parameters of the co-promotion.

20. A computer system, comprising:
a server configured to store a plurality of location accounts, each location account being associated with a physical space at a recorded geospatial location, the plurality of location accounts utilizing shared data definitions of a physical space parameter, each physical space being equipped with a corresponding on-premise sensor configured to detect measured values for the physical space parameter over time and send to the server a data stream indicating the measured values;
wherein the server includes a promotion engine configured to aggregate measured values of the physical space parameter for the plurality of location accounts and determine a trend associated with the aggregated measured values for the plurality of location accounts and generate co-promotions between two or more location accounts based on the determined trend; and
a user interface system, via which an authorized user for a location account can view and accept a co-promotion between the location account and one or more other location accounts generated by the promotion engine.
